(19) United States
(12) Patent Application Publication
(10) Pub. No.: US 2010/0224661 A1
(43) Pub. Date: Sep. 9, 2010

(54) Retaining Device

(75) Inventor: Michael Egan, Blacktown (AU)

Correspondence Address: LOCKE LORD BISSELL & LIDDELL LLP;ATTN: IP DOCKETING, 600 TRAVIS, SUITE 3400, HOUSTON, TX, 77002-3095, US

(73) Assignee: MERCANE PTY LTD, Blacktown (AU)

(21) Appl. No.: 12/095,572

(22) PCT Filed: Nov. 29, 2006
(86) PCT No.: PCT/AU06/01802

§ 371 Date: May 30, 2008

(30) Foreign Application Priority Data
Nov. 30, 2005 (AU) 2005906712

(51) Int. Cl. B62J 9/00

(52) U.S. Cl. 224/413

(57) ABSTRACT

A retaining device (1) is disclosed. The retaining device is for selectively attaching an electronic toll transponder to a motorcycle, and it includes retaining means (2) for retaining the transponder, and a magnet (3) coupled to the retaining means for magnetically engaging with a portion of the motorcycle for selectively attaching the retaining device thereto.

### FIELD OF THE INVENTION

The present invention relates to a retaining device and a mounting device, and in particular to a retaining device for retaining an electronic toll collection system transponder, and a mounting device for facilitating the mounting of such a retaining device.

The invention has been developed primarily for use with a motorcycle and will be described hereinafter with reference to this application. However, it will be appreciated that the invention is not limited to this particular field of use.

### BACKGROUND

Any discussion of the prior art throughout the specification should in no way be considered as an admission that such prior art is widely known or forms part of the common general knowledge in the field.

Where it is desired that a toll should be payable for use of a highway, electronic toll collection systems are common in which toll stations are located at intervals along the highway. Vehicles are provided with a transponder activatable to transmit account identification information. The toll stations are provided with one or more RF antennae above or adjacent the traffic lanes. The antennae activate the transponders in vehicles passing under or beside them and receive the transmitted account information. A computer checks the received account information against a database to ensure that the account is active, etc, and the appropriate toll is deducted from the account. In some systems, transponders provide audiovisual indications, such as a beep and/or the illumination of a light to indicate that the toll has been paid.

Some such systems have barriers which are opened upon successful payment of the toll. However, these barriers cause a significant slowing in the flow of traffic. Other systems to not have barriers; instead, the passage of a vehicle is sensed and still or video cameras photograph vehicles which pass without a toll having been paid. The drivers of such vehicles are typically susceptible to a fine and/or prosecution.

While transponders are readily available, not all vehicles may have one. For example, rental cars or those of visitors to an area may not have the necessary transponder. The drivers of such vehicles must go to a cash station where the driver pays the toll in cash to an operator or by insertion into a machine. This may slow the passage of those vehicles significantly in comparison with those vehicles having transponders. Historically, motorcycles in particular have not been provided with transponders, since their open nature renders tags vulnerable to theft. However, motorcyclists typically wear gloves and protective clothing which must be removed or loosened to enable the rider to retrieve cash to pay a toll. Thus, the slowing of vehicles is particularly significant in the case of motorcycles.

Known solutions to this problem include the rider of a motorcycle carrying a transponder in a pocket or a bag. However, while the antennae are capable of reading transponders through one or more layers of material, the orientation of the transponder relative to an antenna is critical to a certain degree. Thus, in the case of a system without barriers, it is possible for the rider of a motorcycle intending to pay the toll to pass without paying, rendering him susceptible to the above penalties.

### SUMMARY OF THE INVENTION

It is an object of the present invention to overcome or alleviate at least one of the disadvantages of the prior art, or to provide a useful alternative.

According to a first aspect of the invention, there is provided a retaining device for selectively attaching an electronic toll transponder to a motorcycle, the retaining device including:

retaining means for retaining the transponder; and

a magnet coupled to the retaining means for magnetically engaging with a portion of the motorcycle for selectively attaching the retaining device thereto.

Preferably, the retaining means defines a chamber for substantially enclosing the transponder.

The retaining means preferably includes an aperture for receiving the transponder. A closure for closing the aperture, for example using hook-and-eye fastening tabs, is preferably also provided.

Preferably, the retaining means includes a viewing aperture or window for allowing the viewing of a visual indication provided by a transponder inserted in the chamber.

In one preferred embodiment, the retaining means is formed of leather or a textile material.

In an alternative preferred embodiment, the retaining means includes a first moulded portion for retaining the transponder. A second moulded portion for holding the magnet is preferably also provided. The first and second portions may preferably be integrally formed, for example of a plastics material.

A second aspect of the invention provides a mounting device for attachment to a motorcycle for facilitating the mounting thereto of a retaining device as set out above, the mounting device including:

fixing means for fixing the mounting device to the motorcycle; and

a magnetic portion coupled to the fixing means for magnetically engaging with the magnet of the retaining device.

In one preferred embodiment, the fixing means includes a threaded bolt for insertion in an aperture in a panel of a motorcycle. A complementarily-threaded nut is preferably also provided.

In an alternative embodiment, the fixing means includes clamping means for clamping around a portion of the motorcycle, for example a handlebar of the motorcycle.

In other aspects an embodiment of the mounting device is provided in conjunction with an embodiment of the retaining device in a kit.

### BRIEF DESCRIPTION OF THE DRAWINGS

Preferred embodiments of the invention will now be described, by way of example only, with reference to the accompanying drawings, in which:

FIG. 1 shows a first example of a retaining device for selectively attaching an electronic toll transponder to a motorcycle;

FIG. 2 shows a second example of a retaining device for selectively attaching an electronic toll transponder to a motorcycle;

FIG. 3 shows a first example of a mounting device for attachment to a motorcycle, and

FIG. 4 shows a second example of a mounting device for attachment to a motorcycle.

### DETAILED DESCRIPTION

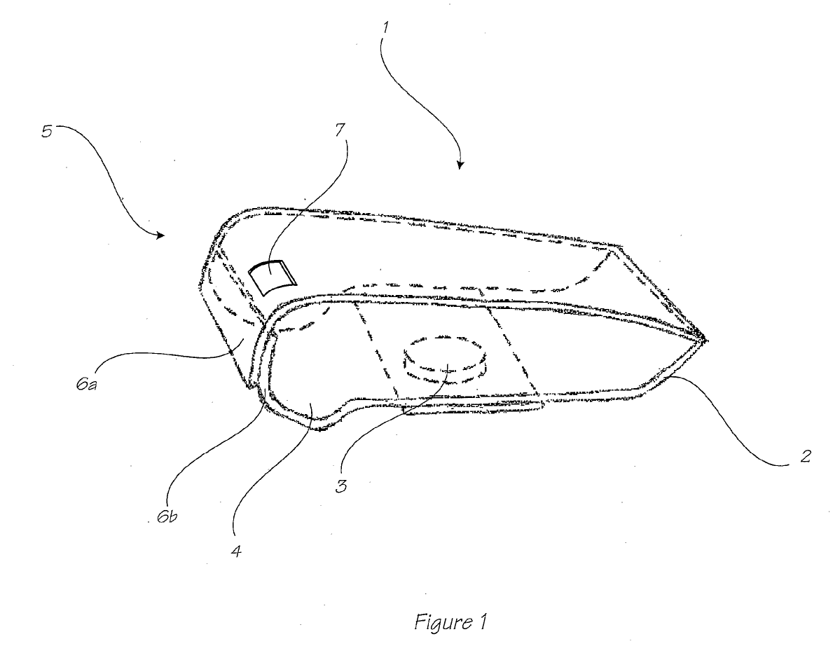

FIG. 1 shows a first example of a retaining device 1 for selectively attaching an electronic toll transponder to a motorcycle. The retaining device 1 includes retaining means 2. A magnet 3 is coupled to the retaining means 2 for magnetically engaging with a portion of a motorcycle for selectively attaching the retaining device thereto. For example, the retaining device 1 may be attached to a headlamp, a headlamp bracket or the headstock of a motorcycle, or any other magnetic portion thereof suitably disposed to allow the retaining device 1 to sit against it such that the transponder retained thereby is correctly oriented to operate in an electronic toll collection system.

In the example shown in FIG. 1, the retaining means 2 is formed of leather or a textile material. In particularly preferred embodiments, the retaining means is formed of a waterproof material, such as a waterproof canvass, or a plastics material. The retaining means defines a chamber 4 for substantially enclosing the transponder, and an aperture 5 is provided in the retaining means 2 for receiving the transponder. The aperture 5 is selectively closable using hook-and-eye fastening tabs 6a, 6b.

The retaining means 2 includes a viewing aperture or window 7 for allowing the viewing of a visual indication provided by a transponder inserted in the chamber 4.

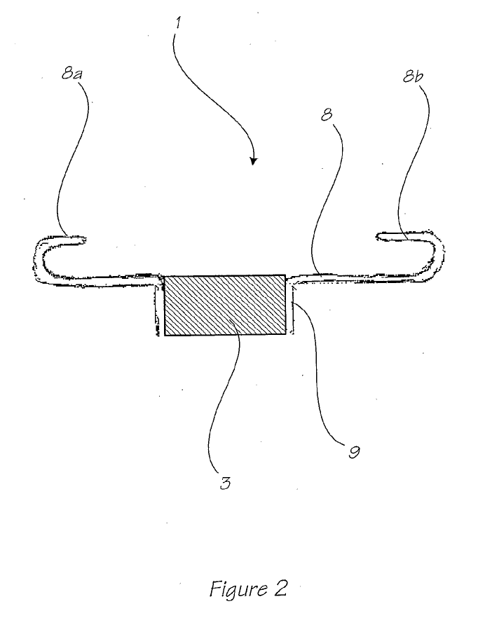

FIG. 2 shows a second example of a retaining device 1 for selectively attaching an electronic toll transponder to a motorcycle; parts corresponding with those of the example shown in FIG. 1 are denoted using corresponding reference numerals. In this example, the retaining means 2 includes a first moulded portion 8, including re-entrant lips 8a, 8b, for retaining the transponder, and a second moulded portion 9 for holding the magnet 3. The first and second moulded portions are integrally formed of a plastics material.

In either of the above-described examples of a retaining device, the magnet 3 may have any suitable cross-sectional shape. For example, round magnets, as shown in FIG. 1, may be used. However, to reduce the likelihood of rotation of the retaining device when exposed to wind, magnets having a greater maximum edge-to-edge distance for a given surface area, such as square magnets, may be used. Additionally or alternatively, two or more spaced-apart magnets may also be used to reduce the likelihood of rotation of the retaining device.

Electronic toll transponders typically have an orientation in which they must be placed to operate correctly with the electronic toll collection system. In particular, a specified major surface of the transponder must face generally outwards with respect to the vehicle, and/or generally forwards or upwards.

To use the retaining devices 1 shown in FIGS. 1 and 2, a transponder is inserted into the retaining means 2 such that the surface of the transponder which must face away from the vehicle faces away from the magnet 3. The retaining device 1 is then attached to a magnetic portion of the motorcycle. It may be necessary to try a number of locations on a motorcycle to determine a position in which the transponder functions correctly. Potentially suitable locations include headlamps, headlamp brackets, the fuel tank, the headstock, and so on. However, two examples of a retaining device will now be described in situations in which no suitable or acceptable location on a motorcycle may be found.

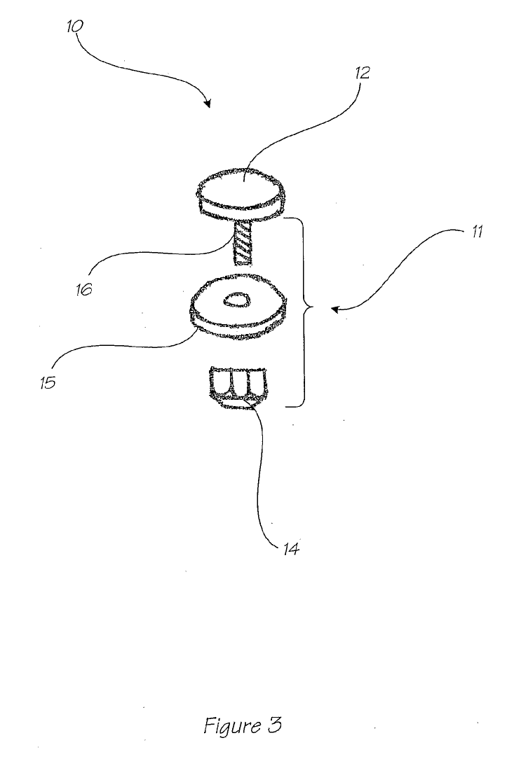

FIG. 3 shows a first example of a mounting device 10 for attachment to a motorcycle for facilitating the mounting thereto of a retaining device 1 as shown in FIG. 1 or FIG. 2. The mounting device 10 includes fixing means 11 for fixing the mounting device to the motorcycle. A magnetic portion 12 is coupled to the fixing means 11 for magnetically engaging with the magnet 3 of the retaining device. Such a mounting device is used to provide a magnetic portion to which the retaining device shown in FIG. 1 or FIG. 2 may be attached. The example shown in FIG. 3 is suitable for use with motorcycles which include non-magnetic body panels or fairings through which an aperture may be drilled. Thus, in the example shown in FIG. 3, the fixing means 11 includes a threaded bolt 13 for insertion in an aperture in a panel of a motorcycle. The fixing means 11 further includes a complementarily-threaded nut 14 for threading onto the bolt 13 to clamp the body panel and a washer 15.

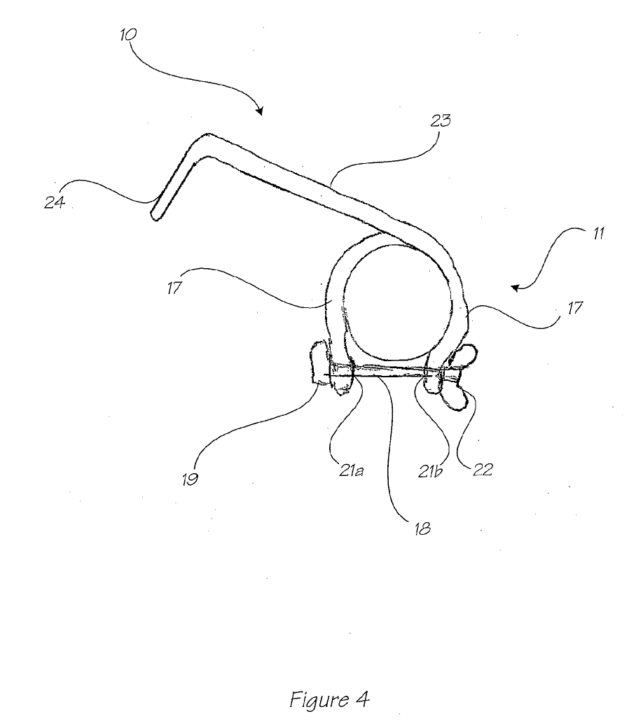

FIG. 4 shows an alternative mounting device 10, which does not require the forming of an aperture in a fairing. This example of a mounting device includes clamping means 16 for clamping around a portion of the motorcycle, such as a handlebar. This example includes generally C-shaped clamping jaws 17 for clamping around a handlebar. The jaws are retained in place using a bolt 18, having a lug 19 at one end and a threaded portion 20 at the other. When the clamping jaws are placed around the handlebar, the bolt 18 is threaded through respective apertures 21a, 21b in the jaws such that the lug 19 bears upon the outer surface of one jaw, and the threaded portion 20 extends through the other jaw. A wingnut 22 is threaded onto the threaded portion of the bolt 18 and tightened to bear upon the outer surface of the jaw.

An arm 23 extends generally tangentially from the jaws 17, and a magnetic portion 24 for magnetic engagement with a retaining device is supported by the arm 23.

In a further alternative, a magnet or a plate of magnetic material may simply be adhered to a panel of a motorcycle to provide a location to which the retaining device may be attached.

It will be appreciated that further embodiments and exemplifications of the invention are possible without departing from the spirit or scope of the invention described.

1. A retaining device for selectively attaching an electronic toll transponder to a motorcycle, the retaining device comprising:
retaining means for retaining the transponder; and
a magnet coupled to the retaining means for magnetically engaging with a portion of the motorcycle for selectively attaching the retaining device thereto.

2. A retaining device according to claim 1, wherein the retaining means defines a chamber for substantially enclosing the transponder.

3. A retaining device according to claim 2, wherein the retaining means includes an aperture for receiving the transponder.

4. A retaining device according to claim 3, wherein the retaining means further includes a closure for closing the aperture.

5. A retaining device according to claim 4, wherein the closure is selectively closable using hook-and-eye fastening tabs.

6. A retaining device according to claim 2, wherein the retaining means includes a viewing aperture or window for allowing the viewing of a visual indication provided by a transponder inserted in the chamber.

7. A retaining device according to claim 2, wherein the retaining means is formed of leather or a textile material.

8. A retaining device according to claim 1, wherein the retaining means includes a first moulded portion for retaining the transponder.

9. A retaining device according to claim 8, further comprising a second moulded portion for holding the magnet.

10. A retaining device according to claim 9, wherein the first and second moulded portions are integrally formed.

11. A retaining device according to claim 8, wherein at least a portion of the device is formed of a plastics material.

12. A mounting device for attachment to a motorcycle for facilitating the mounting thereto of a retaining device as claimed in claim 1, the mounting device comprising:
fixing means for fixing the mounting device to the motorcycle; and
a magnetic portion coupled to the fixing means for magnetically engaging with the magnet of the retaining device.

13. A mounting device according to claim 12, wherein the fixing means includes a threaded bolt for insertion in an aperture in a panel of a motorcycle.

14. A mounting device according to claim 13, wherein the fixing means further includes a complementarily-threaded nut.

15. A mounting device according to claim 12, wherein the fixing means includes clamping means for clamping around a portion of the motorcycle.

16. A mounting device according to claim 15, wherein the clamping means is adapted for clamping around a handlebar of the motorcycle.

17. (canceled)

18. (canceled)

19. A mounting device for attachment to a motorcycle for facilitating the mounting thereto of a retaining device as claimed in claim 2, the mounting device comprising:
fixing means for fixing the mounting device to the motorcycle; and
a magnetic portion coupled to the fixing means for magnetically engaging with the magnet of the retaining device.

20. A mounting device for attachment to a motorcycle for facilitating the mounting thereto of a retaining device as claimed in claim 3, the mounting device comprising:
fixing means for fixing the mounting device to the motorcycle; and
a magnetic portion coupled to the fixing means for magnetically engaging with the magnet of the retaining device.

21. A mounting device for attachment to a motorcycle for facilitating the mounting thereto of a retaining device as claimed in claim 4, the mounting device comprising:
fixing means for fixing the mounting device to the motorcycle; and
a magnetic portion coupled to the fixing means for magnetically engaging with the magnet of the retaining device.

22. A mounting device for attachment to a motorcycle for facilitating the mounting thereto of a retaining device as claimed in claim 5, the mounting device comprising:
fixing means for fixing the mounting device to the motorcycle; and
a magnetic portion coupled to the fixing means for magnetically engaging with the magnet of the retaining device.
